(19) United States
(12) Patent Application Publication
(10) Pub. No.: US 2015/0192213 A1
(43) Pub. Date: Jul. 9, 2015

(54) VALVE DEVICE WITH EXCESS FLOW PREVENTION FUNCTION

(71) Applicant: KAWASAKI JUKOGYO KABUSHIKI KAISHA, KObe-shi, Hyogo (JP)

(72) Inventors: Kaoru Nomichi, Ono-shi (JP); Makoto Ninomiya, Kobe-shi (JP); Tadahiko Kuroda, Akashi-shi (JP); Yutaka Suzuki, Kobe-shi (JP)

(21) Appl. No.: 14/408,463

(22) PCT Filed: Mar. 26, 2014
(86) PCT No.: PCT/JP2014/001739

§ 371 Date: Dec. 16, 2014

(30) Foreign Application Priority Data
Apr. 25, 2013 (JP) 2013-092403

(51) Int. Cl. F16K 17/10; G05D 16/20

(52) U.S. Cl. CPC F16K 17/10; G05D 16/20

(57) ABSTRACT

A valve device includes: a main valve element arranged so as to divide a valve element space of a housing into a first pressure chamber and a second pressure chamber; and a pilot valve element arranged in the second pressure chamber. A first pilot passage including a first restrictor extends from an outside of the housing or the primary passage to the second pressure chamber, and a second pilot passage including a second restrictor is formed at the main valve element. The pilot valve element is biased by a biasing member to close an upstream end of the second pilot passage. When electric power is supplied to a drive unit, the pilot valve element opens the upstream end of the second pilot passage. An excess flow prevention valve including a third restrictor is provided at the second pilot passage so as to be located downstream of the second restrictor.

### TECHNICAL FIELD

The present invention relates to a valve device with an excess flow prevention function, the valve device being capable of closing a main passage when a large amount of fluid flows through the main passage.

### BACKGROUND ART

Gas consuming devices, such as gas engines and fuel cells, configured to consume a gas to generate driving force or electric power are known. The gas consuming device is connected through a valve device to a pressure vessel that stores a gas to be supplied to the gas consuming device. The valve device can switch to supply the gas from the pressure vessel to the gas consuming device and stop the supply of the gas. One example of the valve device is disclosed in PTL 1.

In the valve device of PTL 1, a main stop valve and an excess flow prevention valve are arranged in series on a fuel supply passage that connects an engine and a gas container. The main stop valve opens or closes the fuel supply passage in accordance with an on or off operation of an engine switch. The excess flow prevention valve is configured to close the fuel supply passage to stop the supply of the gas from the gas container to the engine when a pressure difference across the excess flow prevention valve becomes large. Therefore, even in a case where the main stop valve cannot be closed when a pipe of the fuel supply passage breaks, and a large amount of gas flows out, the fuel supply passage is closed by the excess flow prevention valve.

### CITATION LIST

### Patent Literature

PTL 1: Japanese Laid-Open Patent Application Publication No. 2002-115798

### SUMMARY OF INVENTION

### Technical Problem

In the valve device described in PTL 1, the excess flow prevention valve is arranged at the fuel supply passage. Therefore, the flow rate of the gas flowing through the excess flow prevention valve is the same as the flow rate of the gas flowing through the main stop valve. On this account, it is necessary to use the excess flow prevention valve having such a size that can endure the high flow rate of the gas. However, an outer dimension of the excess flow prevention valve that can endure the high flow rate of the gas is large, and the cost is high because of the necessity of increasing a withstand pressure performance of the excess flow prevention valve. Further, since the excess flow prevention valve is disposed on the main passage (fuel supply passage) that connects the gas consuming device and the gas container, the pressure loss of the main passage becomes large.

Here, an object of the present invention is to provide a valve device with an excess flow prevention function, the valve device being capable of reducing the size of an excess flow prevention valve and also reducing the pressure loss of a main passage.

### Solution to Problem

To solve the above problems, a valve device with an excess flow prevention function according to the present invention includes: a housing, at which a primary passage and a secondary passage constituting a main passage are formed and which includes a valve element space located between the primary passage and the secondary passage; a main valve element arranged in the housing so as to divide the valve element space into a first pressure chamber and a second pressure chamber, the first pressure chamber communicating with the primary passage and the secondary passage, the main valve element being configured to open or close the main passage in accordance with a differential pressure between the first pressure chamber and the second pressure chamber; a sealing member arranged between the housing and the main valve element to isolate the first pressure chamber from the second pressure chamber; a first pilot passage extending from an outside of the housing or the primary passage to the second pressure chamber and including a first restrictor; a second pilot passage formed at the main valve element so as to extend from the second pressure chamber to the secondary passage and including a second restrictor; a pilot valve element arranged in the second pressure chamber and configured to open or close an upstream end of the second pilot passage; a pilot valve element biasing member configured to bias the pilot valve element toward the main valve element to bring the pilot valve element in contact with the main valve element; a drive unit configured to separate the pilot valve element from the main valve element by power supply against biasing force of the pilot valve element biasing member; and an excess flow prevention valve provided at the second pilot passage so as to be located downstream of the second restrictor and including a third restrictor, the excess flow prevention valve being configured to open or close the second pilot passage in accordance with a difference between pressure upstream of the third restrictor and pressure downstream of the third restrictor.

According to the above configuration, when electric power is supplied to the drive unit, the pilot valve element opens the upstream end of the second pilot passage. With this, a fluid flows through the first pilot passage, the second pressure chamber, and the second pilot passage, and the pressure of the second pressure chamber becomes lower than the pressure of the first pressure chamber by the actions of the first to third restrictors. As a result, the main valve element opens the main passage, so that the fluid flows through the main passage.

When the flow rate of the main passage becomes too high, the flow rate of the second pilot passage also becomes too high. Thus, the difference between the pressure upstream of the third restrictor and the pressure downstream of the third restrictor becomes large, so that the excess flow prevention valve closes the second pilot passage. With this, the pressure of the second pressure chamber increases up to the pressure of the first pressure chamber, so that the main valve element closes the main passage. To be specific, the excess flow prevention function of the main passage can be achieved by the excess flow prevention valve provided at the second pilot passage. Since the flow rate of the second pilot passage is lower than the flow rate of the main passage, a low flow rate type excess flow prevention valve can be adopted. Therefore, the valve device can be reduced in size and cost. In addition, since the excess flow prevention valve is provided at the second pilot passage, the pressure loss of the main passage can be made smaller than that in a conventional case where the excess flow prevention valve is provided at the main passage.

The above valve device may further include a main valve element biasing member configured to bias the main valve element in such a direction that the main valve element closes the main passage. According to this configuration, when, for example, the supply of the fluid is stopped at position downstream of the valve device, the main passage can be closed by the main valve element.

The above valve device may be configured such that the main valve element is supported by the housing via a linear motion bearing member. According to this configuration, the sliding resistance and abrasion of the main valve element can be reduced, and the responsiveness and durability of the main valve element can be improved.

The above valve device may be configured such that: the valve device is inserted in a pressure vessel such that a part of the valve device is exposed from the pressure vessel; the primary passage is open to an internal space of the pressure vessel; and the drive unit is arranged in the pressure vessel. According to this configuration, it is possible to prevent a case where if impacts are applied to the pressure vessel from outside due to accidents or the like, major portions of the valve device directly receives the external force, and the valve device is damaged to become the open state. Therefore, the fluid in the pressure vessel can be prevented from flowing out.

### Advantageous Effects of Invention

According to the present invention, the excess flow prevention valve can be reduced in size, and the pressure loss of the main passage can be reduced.

### BRIEF DESCRIPTION OF DRAWINGS

FIG. 1 is a cross-sectional view of a valve device with an excess flow prevention friction according to one embodiment of the present invention.

FIG. 2 is an enlarged view of major portions of FIG. 1.

FIG. 3 is a schematic diagram of the valve device shown in FIG. 1 and shows an open state of an excess flow prevention valve.

FIG. 4 is a schematic diagram of the valve device shown in FIG. 1 and shows a closed state of the excess flow prevention valve.

FIG. 5 is a graph showing a relation between a main flow rate and a differential pressure as well as a relation between the main flow rate and a pilot flow rate.

FIG. 6 is a schematic diagram of the valve device of Modification Example.

### DESCRIPTION OF EMBODIMENTS

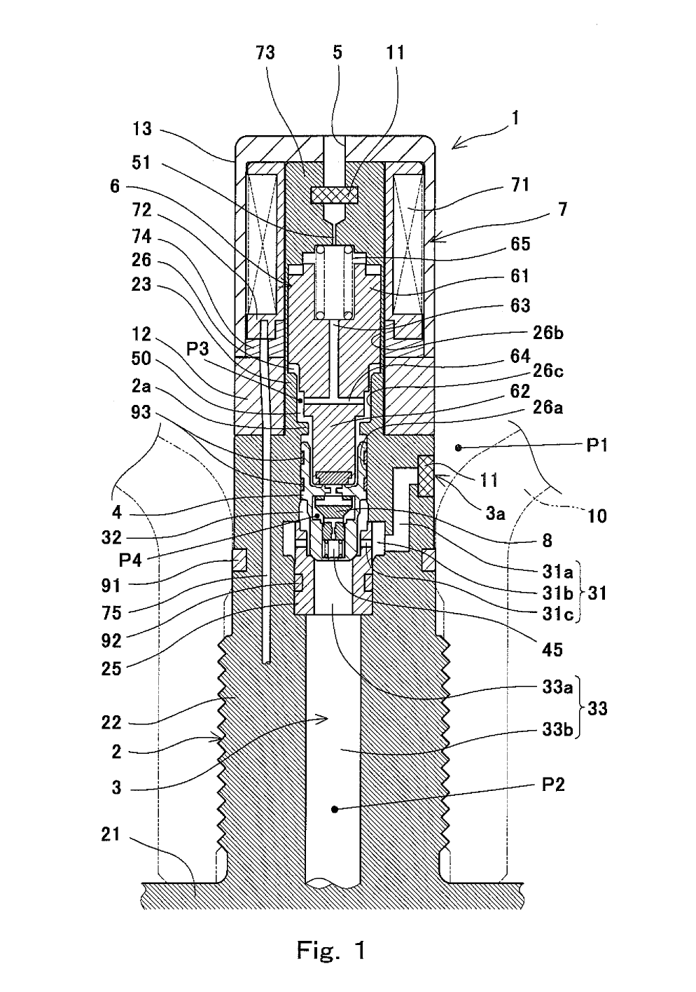

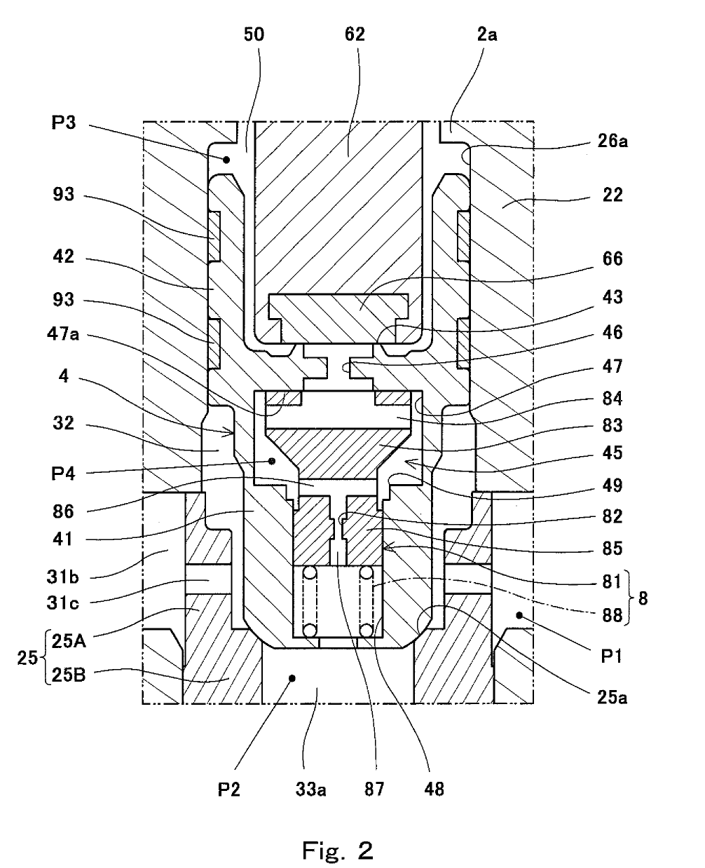

Each of FIGS. 1 and 2 shows a valve device 1 with an excess flow prevention function according to one embodiment of the present invention. The valve device 1 of the present embodiment is an in-tank type solenoid valve device that is inserted in a pressure vessel 10 such that a part of the valve device is exposed from the pressure vessel 10. The pressure vessel 10 is, for example, a gas tank.

Specifically, the valve device 1 includes: a housing 2; a main valve element 4 and a pilot valve element 6 arranged in the housing 2; and a solenoid unit (drive unit) 7 configured to drive the pilot valve element 6. A spacer 12 is arranged between the solenoid unit 7 and the housing 2, and the solenoid unit 7 is covered with a case 13.

The valve device 1 is configured such that most of the valve device 1 including the solenoid unit 7 is arranged in the pressure vessel 10 except for a part of the housing 2. Therefore, it is possible to prevent a case where if impacts are applied to the pressure vessel 10 from outside due to accidents or the like, major portions (especially, the solenoid unit 7) of the valve device 1 directly receives the external force, and the valve device 1 is damaged to become the open state. To be specific, a fluid (gas) in the pressure vessel 10 can be prevented from flowing out.

The valve device 1 is not limited to the solenoid valve that adopts the solenoid unit 7 as the drive unit. For example, a piezoelectric actuator may be used as the drive unit. The piezoelectric actuator includes a piezoelectric element (for example, a piezo element) and generates driving force in accordance with an applied voltage. Or, a force motor may be used as the drive unit. The force motor is configured such that: a movable coil is inserted in a cylindrical permanent magnet; when a current is supplied to the movable coil, the movable coil generates magnetizing force corresponding to the current; and the movable coil moves by this magnetizing force.

The housing 2 is configured to close an opening portion of the pressure vessel 10. More specifically, the housing 2 includes: a base portion 21 located outside the pressure vessel 10; a large shaft portion 22 projecting from the base portion 21 to an inside of the pressure vessel 10; and a small shaft portion 23 further projecting from a tip end of the large shaft portion 22 to the inside of the pressure vessel 10. The large shaft portion 22 and the small shaft portion 23 are cylindrical, and central axes thereof are located on the same straight line. Hereinafter, for convenience of explanation, a direction toward the inside of the pressure vessel 10 along the central axes of the shaft portions 22 and 23 is referred to as an upper direction, and a direction toward the outside of the pressure vessel 10 along the central axes of the shaft portions 22 and 23 is referred to as a lower direction.

A screw thread that is threadedly engaged with the opening portion of the pressure vessel 10 is formed on an outer peripheral surface of the large shaft portion 22. A sealing member 91 configured to seal a gap between the large shaft portion 22 and the pressure vessel 10 is attached to the large shaft portion 22 so as to be located above the screw thread. The above-described spacer 12 having flat upper and lower surfaces and a ring shape is fitted to a base of the small shaft portion 23. The above-described case 13 includes: a peripheral wall extending upward from a peripheral portion of the upper surface of the spacer 12; and a main wall that closes an upper opening of the peripheral wall.

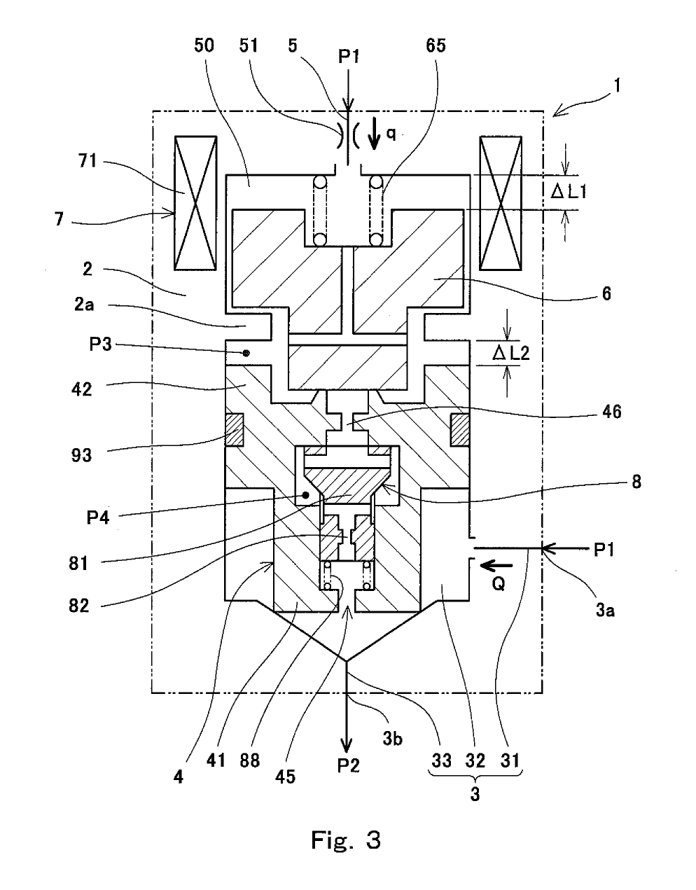

A primary passage 31 and a secondary passage 33 constituting a main passage 3 are formed at the housing 2. In the present embodiment, the primary passage 31 is formed at the large shaft portion 22, and the secondary passage 33 is formed at the large shaft portion 22 and the base portion 21. An upstream end of the primary passage 31 constitutes a primary port 3a that is open on the outer peripheral surface of the large shaft portion 22 toward an internal space of the pressure vessel 10. A downstream end of the secondary passage 33 constitutes a secondary port 3b (see FIG. 3) that is open on an end surface of the base portion 21 toward the outside. A filter 11 is provided at the primary port 3a.

The housing 2 includes a valve element space 26 located between the primary passage 31 and the secondary passage 33. In the present embodiment, the valve element space 26 extends in both the large shaft portion 22 and the small shaft portion 23.

More specifically, a first sliding chamber 26a configured to hold the main valve element 4 such that the main valve element 4 can slide in the upper-lower direction is formed at the large shaft portion 22. A second sliding chamber 26b configured to hold the pilot valve element 6 such that the pilot valve element 6 can slide in the upper-lower direction is formed at the small shaft portion 23. A middle chamber 26c is formed between the first sliding chamber 26a and the second sliding chamber 26b so as to connect the first sliding chamber 26a and the second sliding chamber 26b. Further, a tubular member 25 extending in the upper-lower direction is arranged in the large shaft portion 22 so as to be located under the first sliding chamber 26a. The tubular member 25 is a part of the housing 2.

The tubular member 25 includes: a thick portion 25B having a relatively small inner diameter and located at a lower side; and a thin portion 25A having a relatively large inner diameter and located at an upper side. A first valve seat 25a for the main valve element 4 is formed at a step portion between the thick portion 25B and the thin portion 25A.

The above-described valve element space 26 is a continuous space surrounded by: wall surfaces that define the second sliding chamber 26b, the middle chamber 26c, and the first sliding chamber 26a; and an inner peripheral surface of the thin portion 25A of the tubular member 25.

At the large shaft portion 22, an annular groove 31b is formed so as to surround the thin portion 25A of the tubular member 25, and a passage 31a is formed so as to extend from the primary port 3a to the annular groove 31b. A plurality of through holes 31c are formed at the thin portion 25A of the tubular member 25 so as to penetrate the thin portion 25A. The passage 31a, the annular groove 31b, and the through holes 31c constitute the primary passage 31.

Further, a passage 33b is formed at the large shaft portion 22 and base portion 21 of the housing 2 so as to extend from a lower opening of the tubular member 25 to the secondary port 3b. The passage 33b and an inside 33a of the thick portion 25B of the tubular member 25 constitute the secondary passage 33. A sealing member 92 configured to prevent a fluid from leaking from the annular groove 31b to the passage 33b is attached to the thick portion 25B of the tubular member 25.

The main valve element 4 is arranged in the housing 2 so as to divide the valve element space 26 into a first pressure chamber 32 and a second pressure chamber 50, the first pressure chamber 32 communicating with the primary passage 31 and the secondary passage 33. The first pressure chamber 32, the primary passage 31, and the secondary passage 33 constitute the main passage 3. The main valve element 4 opens or closes the main passage 3 in accordance with the differential pressure between the first pressure chamber 32 and the second pressure chamber 50.

More specifically, the main valve element 4 includes: a shaft portion 41 inserted in the thin portion 25A of the tubular member 25; and a tubular portion 42 extending upward from an upper peripheral portion of the shaft portion 41 and having an outer diameter larger than a diameter of the shaft portion 41. The tubular portion 42 is held by the first sliding chamber 26a so as to be slidable, and the shaft portion 41 is spaced apart from the thin portion 25A of the tubular member 25. To be specific, the first pressure chamber 32 is formed between a portion of a wall surface defining the first sliding chamber 26a, the portion being located under the tubular portion 42, and an outer peripheral surface of the shaft portion 41 as well as between the inner peripheral surface of the thin portion 25A of the tubular member 25 and the outer peripheral surface of the shaft portion 41. The second pressure chamber 50 is constituted by: a space facing an upper surface of the shaft portion 41 and an inner peripheral surface of the tubular portion 42; a portion of the first sliding chamber 26a, the portion being located above the main valve element 4; the middle chamber 26c; and the second sliding chamber 26b. Sealing members 93 are attached to the tubular portion 42 so as to be located between the housing 2 and the main valve element 4 and isolate the first pressure chamber 32 from the second pressure chamber 50. The number of sealing members 93 may be one.

When the shaft portion 41 is seated on the first valve seat 25a in the tubular member 25, the first pressure chamber 32 is blocked from the secondary passage 33, and the main passage 3 is closed. When the shaft portion 41 is separated from the first valve seat 25a, the first pressure chamber 32 is connected to the secondary passage 33, and the main passage 3 opens.

A stopper 2a projecting in the second pressure chamber 50 is provided in the middle chamber 26c located above the first sliding chamber 26a. The main valve element 4 moves between a closed position at which the shaft portion 41 is seated on the first valve seat 25a and an open position at which the tubular portion 42 contacts the stopper 2a.

The pilot valve element 6 is arranged in the second pressure chamber 50. A first biasing member (pilot valve element biasing member) 65 is arranged in the second pressure chamber 50. The first biasing member 65 biases the pilot valve element 6 toward the main valve element 4 to bring the pilot valve element 6 in contact with the main valve element 4. The first biasing member 65 is, for example, a compression coil spring. When electric power is supplied to the above-described solenoid unit 7, the solenoid unit 7 separates the pilot valve element 6 from the main valve element 4 against the biasing force of the first biasing member 65. To be specific, the pilot valve element 6 also serves as a movable core driven by the solenoid unit 7.

The solenoid unit 7 includes a coil 71, a bobbin member 72, a magnetic pole member 73, and a yoke member 74. The magnetic pole member 73 is a substantially columnar member provided above the small shaft portion 23 of the housing 2 and facing the valve element space 26. The above-described first biasing member 65 is arranged between the pilot valve element 6 and the magnetic pole member 73. The bobbin member 72 is arranged around the magnetic pole member 73 and the small shaft portion 23, and the coil 71 winds around the bobbin member 72. The yoke member 74 is a ring-shaped member sandwiched between the spacer 12 and the bobbin member 72. A cable 75 extends from the solenoid unit 7 to the outside through the spacer 12 and the large shaft portion 22 and base portion 21 of the housing 2.

A first pilot passage 5 is formed at the magnetic pole member 73 and the main wall of the case 13 so as to extend from the outside of the housing 2, that is, the internal space of the pressure vessel 10 to the second pressure chamber 50. An upstream end, which is open to the internal space of the pressure vessel 10, of the first pilot passage 5 constitutes a pilot port. A first restrictor 51 constituted by a narrow passage is provided at an end portion of the first pilot passage 5, the end portion being located at the second pressure chamber 50 side. The filter 11 is provided at the first pilot passage 5 so as to be located above the first restrictor 51.

A second pilot passage 45 is formed at the main valve element 4 so as to extend from the second pressure chamber 50 to the secondary passage 33 (to be specific, to the inside 33a of the thick portion 25B of the tubular member 25). In the present embodiment, the second pilot passage 45 extends on a center line of the shaft portion 41 in the upper-lower direction. An upstream end of the second pilot passage 45 is open on the upper surface of the shaft portion 41, and a downstream end of the second pilot passage 45 is open on a tip end surface of the shaft portion 41. A second restrictor 46 constituted by an orifice is provided at an end portion of the second pilot passage 45, the end portion being located at the second pressure chamber 50 side.

The pilot valve element 6 opens and closes the upstream end of the second pilot passage 45. More specifically, the pilot valve element 6 includes: a main body portion 61 held by the second sliding chamber 26b so as to be slidable, a lower portion of the main body portion 61 being inserted in the middle chamber 26c; and a shaft portion 62 projecting downward from the main body portion 61 and inserted in the tubular portion 42 of the main valve element 4.

To prevent the pilot valve element 6 from dividing the second pressure chamber 50 into upper and lower parts, a vertical hole 63 located on the center line and a horizontal hole 64 intersecting with a lower end of the vertical hole 63 are formed at the main body portion 61 of the pilot valve element 6. A space under the pilot valve element 6 and a space above the pilot valve element 6 in the second pressure chamber 50 communicate with each other through the vertical hole 63 and the horizontal hole 64.

A second valve seat 43 for the pilot valve element 6 is formed on the upper surface of the shaft portion 41 of the main valve element 4 so as to be located around the upstream end of the second pilot passage 45. A seat member 66 is embedded in a tip end surface of the shaft portion 62 of the pilot valve element 6. When the shaft portion 62 is seated on the second valve seat 43, the upstream end of the second pilot passage 45 is closed. When the shaft portion 62 is separated from the second valve seat 43, the upstream end of the second pilot passage 45 opens. The pilot valve element 6 moves between a first operation position at which the shaft portion 62 is seated on the second valve seat 43 when the main valve element 4 is located at the closed position and a second operation position at which the main body portion 61 is attracted to the magnetic pole member 73.

In the second pressure chamber 50, when the shaft portion 62 of the pilot valve element 6 is separated from the second valve seat 43, the fluid is introduced to the upstream end of the second pilot passage 45 through a gap between an inner peripheral surface of the tubular portion 42 of the main valve element 4 and an outer peripheral surface of the shaft portion 62 of the pilot valve element 6 as well as a gap between the upper surface of the shaft portion 41 of the main valve element 4 and a tip end surface of the shaft portion 62 of the pilot valve element 6.

Here, a stroke ΔL1 (see FIG. 3) of the pilot valve element 6 when it moves between the first operation position and the second operation position is set to be longer than a stroke ΔL2 (see FIG. 3) of the main valve element 4 when it moves between the closed position and the open position. Therefore, when the pilot valve element 6 is located at the second operation position, and the main valve element 4 is located at the open position, a gap is formed between the pilot valve element 6 and the main valve element 4. To be specific, when the main valve element 4 opens the main passage 3, the upstream end of the second pilot passage 45 is also open.

Further, in the present embodiment, an excess flow prevention valve 8 is provided at the second pilot passage 45 so as to be located downstream of the second restrictor 46. The excess flow prevention valve 8 includes a third restrictor 82. The excess flow prevention valve 8 opens or closes the second pilot passage 45 in accordance with a difference between the pressure upstream of the third restrictor 82 (that is, the pressure of the fluid having flowed through the second restrictor 46) and the pressure downstream of the third restrictor 82 (that is, the pressure of the secondary passage 33).

Specifically, the excess flow prevention valve 8 includes an excess flow prevention valve element 81 and a second biasing member 88. A large-diameter portion 47 and a medium-diameter portion 48 are provided at the second pilot passage 45 so as to be located between the second restrictor 46 and the downstream end of the second pilot passage 45. The large-diameter portion 47 is located upstream of the medium-diameter portion 48. A third valve seat 49 for the excess flow prevention valve element 81 is formed at a step portion between the large-diameter portion 47 and the medium-diameter portion 48.

The excess flow prevention valve element 81 includes: a shaft portion 85 held by the medium-diameter portion 48 so as to be slidable; and a head portion 83 located in the large-diameter portion 47 and having a larger diameter than the shaft portion 85. A lower surface of the head portion 83 is a tapered surface. When the head portion 83 is seated on the third valve seat 49, the second pilot passage 45 is closed. When the head portion 83 is separated from the third valve seat 49, the second pilot passage 45 opens.

A gap is formed between an outer peripheral surface of the head portion 83 and an inner peripheral surface of the large-diameter portion 47. A first passage 84 is formed at the head portion 83 so as to be open on an upper surface and outer peripheral surface of the head portion 83. A horizontal hole 86 is formed at an upper portion of the shaft portion 85, and a vertical hole 87 extends from the horizontal hole 86 to a tip end surface (lower surface) of the shaft portion 85 along the center line of the shaft portion 85. The third restrictor 82 is formed at an intermediate position of the vertical hole 87.

The second biasing member 88 biases the excess flow prevention valve element 81 in the upper direction. With this, the head portion 83 is normally pressed against an upper step portion 47a of the large-diameter portion 47. If the difference between the pressure upstream of the third restrictor 82 and the pressure downstream of the third restrictor 82 exceeds a predetermined value a, in other words, if downward force applied to the excess flow prevention valve element 1 by this differential pressure exceeds the biasing force of the second biasing member 88, the excess flow prevention valve element 81 moves downward against the biasing force of the second biasing member 88. With this, the head portion 83 is seated on the third valve seat 49 to close the second pilot passage 45. The second biasing member 88 is, for example, a compression coil spring.

Next, operations of the valve device 1 will be explained in reference to FIGS. 3 to 5. In the following explanations, pressure (that is, primary pressure) in the pressure vessel 10, the primary passage 31, the first pressure chamber 32, and a portion, located upstream of the first restrictor 51, of the first pilot passage 5 is denoted by P1. Pressure (that is, secondary pressure) in the secondary passage 33 and a portion, located downstream of the third restrictor 82 of the excess flow prevention valve 8, of the second pilot passage 45 is denoted by P2. Pressure in the second pressure chamber 50 is denoted by P3. Pressure in a portion extending from the second restrictor 45 to the third restrictor 82 of the excess flow prevention valve 8 in the second pilot passage 45 is denoted by P4. Therefore, the differential pressure between the first pressure chamber 32 and the second pressure chamber 50 is denoted by P4−P3, and the difference between the pressure upstream of the third restrictor 82 of the excess flow prevention valve 8 and the pressure downstream of the third restrictor 82 of the excess flow prevention valve 8 is denoted by P4−P2.

First, a state where the main valve element 4 is located at the closed position as shown in FIG. 3 will be explained. When electric power is not supplied to the solenoid unit 7, the pilot valve element 6 is maintained by the biasing force of the first biasing member 65 at the first operation position at which the shaft portion 62 is seated on the second valve seat 43. At this time, the fluid does not flow through the first pilot passage 5, so that “P3=P1>P2” is realized, and the main valve element 4 is maintained at the closed position. The fluid does not flow through the second pilot passage 45, either, so that “P4=P2” is realized, and the excess flow prevention valve 8 maintains the open state of the second pilot passage 45 by the biasing force of the second biasing member 88.

When electric power is supplied to the solenoid unit 7, the pilot valve element 6 moves to the second operation position at which the main body portion 61 is attracted to the magnetic pole member 73. At this time, the gas flows through the first pilot passage 5 and the second pilot passage 45, so that “P1>P3>P4>P2” is realized.

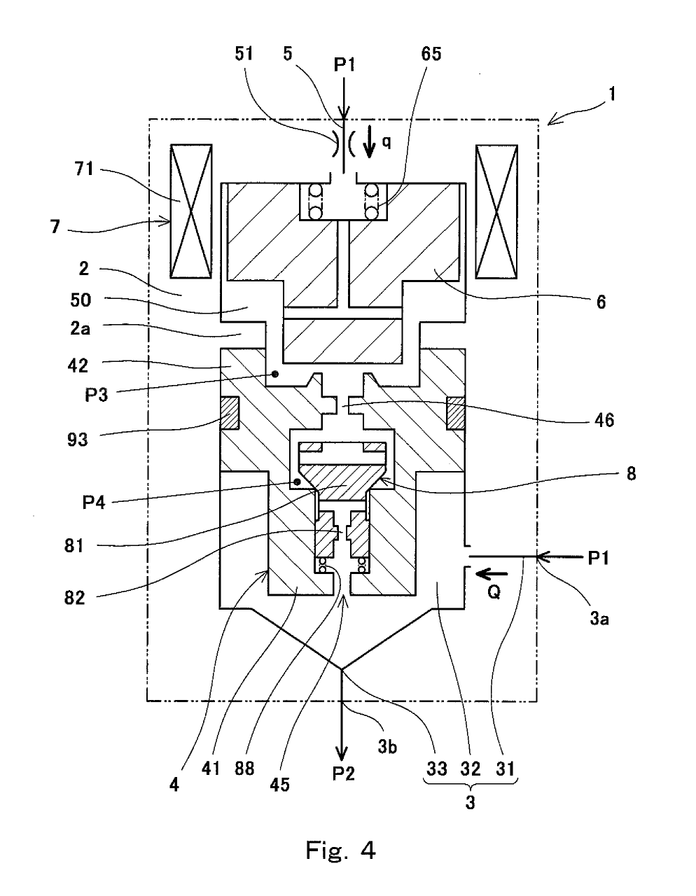

Here, in a case where an annular area obtained by subtracting an area A1 of the first valve seat 25a from a cross-sectional area A0 of the first sliding chamber 26a is denoted by A2 (A2=A0−A1), and the third restrictor 82 is ignored, downward force F1 represented by A1*(P3−P2) and upward force F2 represented by A2*(P1−P3) act on the main valve element 4 located at the closed position. The areas A1 and A2, the first restrictor 51, and the second restrictor 46 are designed to realize “F2>F1”. Therefore, as shown in FIG. 4, the main valve element 4 moves from the closed position to the open position at the same time when the pilot valve element 6 moves to the second operation position.

When electric power supply to the solenoid unit 7 is cut, the pilot valve element 6 closes the upper end of the second pilot passage 45 by the biasing force of the first biasing member 65. With this, the pressure P3 becomes equal to the pressure P1. Thus, the main valve element 4 moves from the open position to the closed position to close the main passage 3.

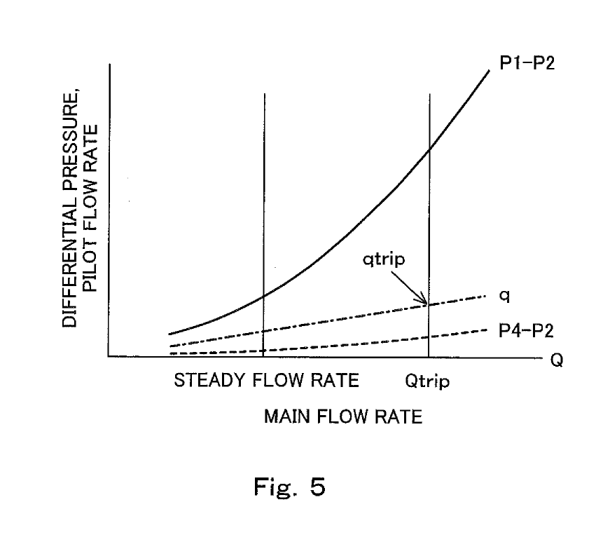

In a case where a main flow rate Q that is the flow rate of the fluid flowing through the main passage 3 is around a steady flow rate, the excess flow prevention valve 8 maintains the open state of the second pilot passage 45. As shown in FIG. 5, as the main flow rate Q increases, differential pressure ΔPm (=P1−P2) increases, and a pilot flow rate q that is the flow rate of the fluid flowing through the first pilot passage 5 and the second pilot passage 45 also increases. With this, differential pressure ΔPp (=P4−P2) also increases.

When the main flow rate Q becomes too high, and the differential pressure ΔPp exceeds the above-described predetermined value a, the excess flow prevention valve element 81 moves downward, and the excess flow prevention valve 8 closes the second pilot passage 45. As a result, “P3−P1>P2” is realized, and the main valve element 4 moves to the closed position to close the main passage 3. A pilot flow rate qₜᵣᵢₚ when the excess flow prevention valve 8 operates is significantly lower than a main flow rate Qₜᵣᵢₚ.

As explained above, the valve device 1 of the present embodiment can achieve the excess flow prevention function of the main passage 3 by the excess flow prevention valve 8 provided at the second pilot passage 45. Since the flow rate of the second pilot passage 45 is lower than the flow rate of the main passage 3, a low flow rate type excess flow prevention valve can be adopted. Therefore, the valve device 1 can be reduced in size and cost. In addition, since the excess flow prevention valve 8 is provided at the second pilot passage 45, the pressure loss of the main passage can be made smaller than that in a conventional case where the excess flow prevention valve is provided at the main passage.

In addition, the valve device 1 of the present embodiment can cause the fluid to flow backward to the main passage 3. Therefore, it is unnecessary to additionally provide a passage for filling the pressure vessel 10 with the fluid. Thus, the pressure vessel 10 can be filled with the fluid by utilizing the main passage 3.

### Other Embodiments

The present invention is not limited to the above-described embodiment. Various modifications may be made within the scope of the present invention.

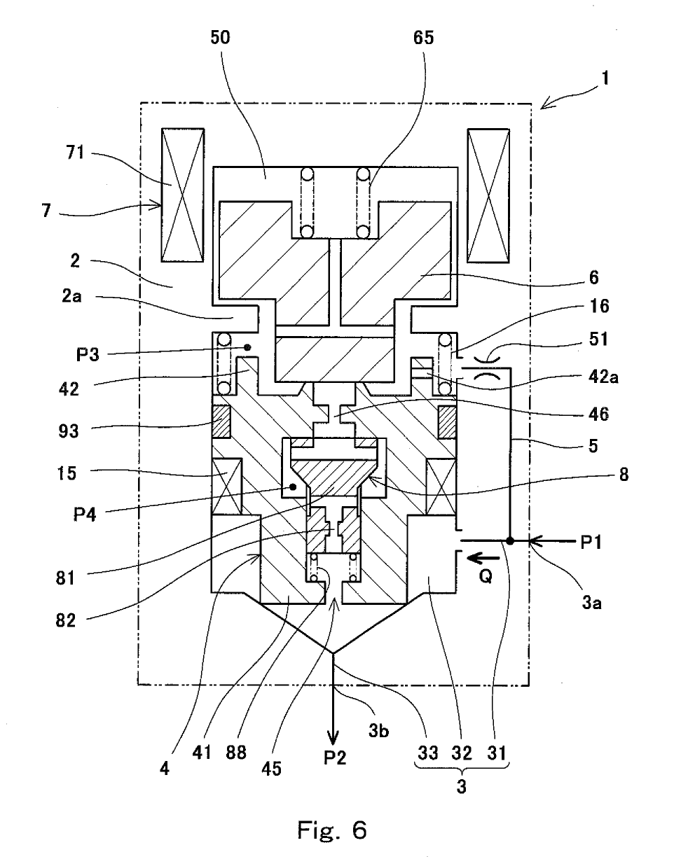

For example, as shown in FIG. 6, the first pilot passage 5 may be formed at the housing 2 so as to extend from the primary passage 31 to the second pressure chamber 50. This configuration is useful in a case where, for example, the valve device 1 is arranged outside the pressure vessel 10.

In the example shown in FIG. 6, a downstream end of the first pilot passage 5 is open immediately under the stopper 2a. Therefore, in order to allow the gas to flow from the first pilot passage 5 to the second pilot passage 45 even when the main valve element 4 is located at the open position, a through hole 42a is formed on a peripheral wall 42 of the main valve element 4.

As shown in FIG. 6, a third biasing member (main valve element biasing member) 16 configured to bias the main valve element 4 in such a direction that the main valve element 4 closes the main passage 3 may be arranged at the second pressure chamber 50. According to this configuration, when, for example, the supply of the fluid is stopped at a position downstream of the valve device 1, the main passage 3 can be closed by the main valve element 4.

Further, as shown in FIG. 6, the main valve element 4 may be supported by the housing 2 via a linear motion bearing member 15. The linear motion bearing member 15 may be a rolling bearing including balls or rollers or may be a sliding bearing, such as a bushing. According to this configuration, the sliding resistance and abrasion of the main valve element 4 can be reduced, and the responsiveness and durability of the main valve element 4 can be improved.

### INDUSTRIAL APPLICABILITY

The present invention is widely applicable to valve devices for various applications.

### REFERENCE SIGNS LIST

1 valve device

10 pressure vessel

15 linear motion bearing member

16 third biasing member (main valve element biasing member)

2 housing

26 valve element space

3 main passage

31 primary passage

32 first pressure chamber

33 secondary passage

4 main valve element

45 second pilot passage

46 second restrictor

5 first pilot passage

50 second pressure chamber

51 first restrictor

6 pilot valve element

65 first biasing member (pilot valve element biasing member)

7 solenoid unit (drive unit)

8 excess flow prevention valve

81 excess flow prevention valve element

82 third restrictor

88 second biasing member

1. A valve device with an excess flow prevention function, the valve device comprising:
a housing, at which a primary passage and a secondary passage constituting a main passage are formed and which includes a valve element space located between the primary passage and the secondary passage;
a main valve element arranged in the housing so as to divide the valve element space into a first pressure chamber and a second pressure chamber, the first pressure chamber communicating with the primary passage and the secondary passage, the main valve element being configured to open or close the main passage in accordance with a differential pressure between the first pressure chamber and the second pressure chamber;
a sealing member arranged between the housing and the main valve element to isolate the first pressure chamber from the second pressure chamber;
a first pilot passage extending from an outside of the housing or the primary passage to the second pressure chamber and including a first restrictor;
a second pilot passage formed at the main valve element so as to extend from the second pressure chamber to the secondary passage and including a second restrictor;
a pilot valve element arranged in the second pressure chamber and configured to open or close an upstream end of the second pilot passage;
a pilot valve element biasing member configured to bias the pilot valve element toward the main valve element to bring the pilot valve element in contact with the main valve element;
a drive unit configured to separate the pilot valve element from the main valve element by electric power supply against biasing force of the pilot valve element biasing member; and
an excess flow prevention valve provided at the second pilot passage so as to be located downstream of the second restrictor and including a third restrictor, the excess flow prevention valve being configured to open or close the second pilot passage in accordance with a difference between pressure upstream of the third restrictor and pressure downstream of the third restrictor.

2. The valve device according to claim 1, further comprising a main valve element biasing member configured to bias the main valve element in such a direction that the main valve element closes the main passage.

3. The valve device according to claim 1, wherein the main valve element is supported by the housing via a linear motion bearing member.

4. The valve device according to claim 1, wherein:
the valve device is inserted in a pressure vessel such that a part of the valve device is exposed from the pressure vessel;
the primary passage is open to an internal space of the pressure vessel; and
the drive unit is arranged in the pressure vessel.

5. The valve device according to claim 2, wherein the main valve element is supported by the housing via a linear motion bearing member.

6. The valve device according to claim 2 wherein:
the valve device is inserted in a pressure vessel such that a part of the valve device is exposed from the pressure vessel;
the primary passage is open to an internal space of the pressure vessel; and
the drive unit is arranged in the pressure vessel.

7. The valve device according to claim 3 wherein:
the valve device is inserted in a pressure vessel such that a part of the valve device is exposed from the pressure vessel;
the primary passage is open to an internal space of the pressure vessel; and
the drive unit is arranged in the pressure vessel.

8. The valve device according to claim 5 wherein:
the valve device is inserted in a pressure vessel such that a part of the valve device is exposed from the pressure vessel;
the primary passage is open to an internal space of the pressure vessel; and
the drive unit is arranged in the pressure vessel.
